(19) United States
(12) Patent Application Publication
(10) Pub. No.: US 2011/0227412 A1
(43) Pub. Date: Sep. 22, 2011

(54) DC VOLTAGE DISTRIBUTION SYSTEM

(76) Inventors: Jian Xu, Windsor (CA); Thomas Alan Barnett, Ypsilanti, MI (US)

(21) Appl. No.: 12/728,400

(22) Filed: Mar. 22, 2010

(51) Int. Cl. H02J 1/10

(52) U.S. Cl. 307/24

(57) ABSTRACT

A DC voltage distribution system includes at least one load connected in parallel to a first DC power supply via a first distance of wire, and connected in parallel to a second DC power supply via a second distance of wire. The first and second DC power supplies are configured to enter a load sharing mode in which one of the first or second DC power supplies selectively increases its voltage to prevent the other of the first or second DC power supplies from exceeding its power output threshold. The DC power supplies are also configured to enter a load balancing mode in which the DC power supplies set their output voltages to the same value such that a flow of current on the longer of the wire distances is reduced and a flow of current on the shorter of the wire distances is increased.

### BACKGROUND

This disclosure relates to DC voltage, and more particularly to a DC voltage distribution system.

Distributing a DC voltage has involved connecting one or more loads to a single DC voltage source. Depending on a distance from the DC voltage source to the one or more loads, a considerable amount of power can be consumed on connection wires due to the voltage of the DC source and the wattage of the loads.

### SUMMARY

A DC voltage distribution system includes at least one load that is connected in parallel to a first DC power supply via a first distance of wire, and is connected in parallel to a second DC power supply via a second distance of wire. The first and second DC power supplies are configured to enter a load sharing mode in which one of the first or second DC power supplies selectively increases its voltage to prevent the other of the first or second DC power supplies from exceeding its power output threshold. The first and second DC power supplies are also configured to enter a load balancing mode in the first DC power supply and the second DC power supply set their output voltage to the same value such that a flow of current on the longer of the first and second distance of wire is reduced and a flow of current on the shorter of the first and second distance of wire is increased.

A method of distributing DC voltage includes distributing DC voltage to at least one load from each of a first DC power supply and a second DC power supply. The at least one load is connected in parallel to each of the first and second DC power supply. A voltage of one of the first or second DC power supplies is selectively increased to prevent the other of the first or second DC power supplies from exceeding its power output threshold in a load sharing mode. In a load balancing mode, the output voltage of the first DC power supply and the output of the second DC power supply are set to the same value such that a flow of current flowing from one of the first or second DC power supplies that has a shorter wiring distance to the at least one load is selectively increased, and a flow of current from the other of the first or second DC power supplies that has a longer wiring distance to the at least one load is decreased.

These and other features of the present disclosure can be best understood from the following specification and drawings, the following of which is a brief description.

### BRIEF DESCRIPTION OF THE DRAWINGS

FIG. 1 schematically illustrates an example DC voltage distribution system.

FIGS. 2-4 schematically illustrate a plurality of example low voltage distribution systems to highlight the efficiency of the system of FIG. 1.

FIG. 5 schematically illustrates an example DC voltage distribution system including three DC power supplies.

FIG. 6 schematically illustrates an example DC voltage distribution system including a powerline communication controller.

### DETAILED DESCRIPTION

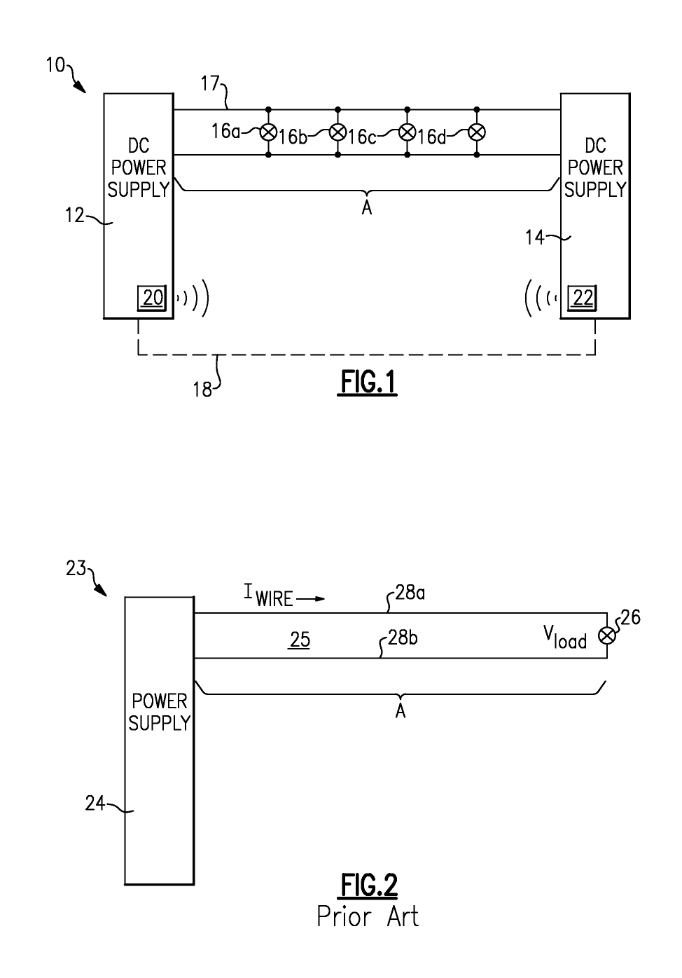

FIG. 1 schematically illustrates a DC voltage distribution system 10 that includes a first DC power supply 12, a second DC power supply 14, and a plurality of loads 16a-d, each of which are connected in parallel to each of the first DC power supply 12 and the second DC power supply 14. The DC power supplies 12, 14 are spaced apart by a wiring distance “A.” The power supplies 12, 14 may communicate with each other through a wired communication line 18, or may communicate wirelessly using wireless transmitters 20, 22, for example.

In the system 10, each of the first DC power supply 12 and the second DC power supply 14 are located at opposite ends of a run of wire 17, such that a wiring distance between the loads 16a-d and either of the DC power supplies 12, 14 (e.g. a distance between power supply 12 and load 16a) does not exceed a wiring distance between the first DC power supply and the second DC power supply (shown as “A”).

The DC power supplies 12, 14 are configured to have load sharing and load balancing modes which yield considerable efficiency improvements over prior art DC distribution systems in which a single DC power supply was used to power one or more loads.

In the load sharing mode, one of the DC power supplies 12, 14 selectively increases its voltage to prevent the other of the DC power supplies 12, 14 from exceeding its power output threshold. In the load balancing mode, the DC power supplies 12, 14 set their output voltages to the same value such that a flow of current from the more distant of the two DC power supplies 12, 14 in relation to a load is reduced and a flow of current from the closer of the two DC power supplies 12, 14 in relation to the load is increased to reduce power consumption. Each of these modes will be discussed in further detail below.

Load Balancing

A. Prior Art Configuration with No Load Balancing

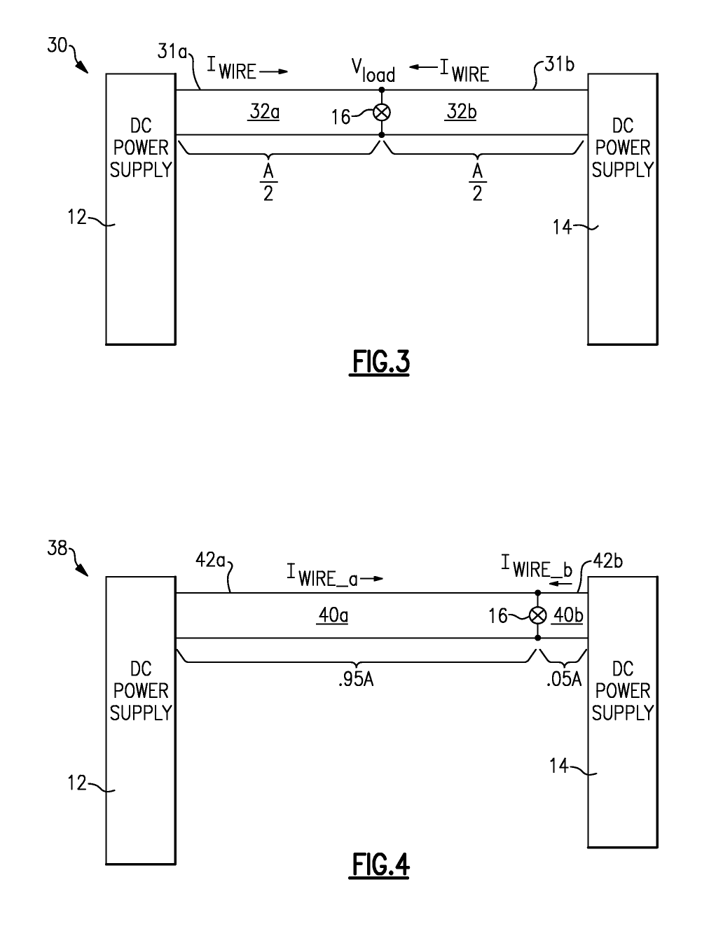

FIG. 2 schematically illustrates a prior art configuration 23 that does not include a load balancing mode. In the configuration 23, a single DC power supply 24 is used to provide power to a load 26, the load 26 being located at a wiring distance A from the power supply 24, forming a current loop 25 having a wiring length of 2*A. Due to the resistive nature of wires forming the loop 25, voltage is dissipated and power is consumed on the wire portions 28a-b. To illustrate the inefficiency of the configuration 23, a worst case scenario is illustrated in which the load 26 is the full distance “A” from the power supply 24. These losses experienced in the configuration 23 may be quantified using equations #1-8 below.

V_{load}=I_{wire}*R_{wire} equation #1

where V_{load} is a voltage drop along the wire loop 25;
I_{wire} is a current along wire portion 28a; and
R_{wire} is a resistance along the wire loop 25.

Assuming that the resistance of wire is 6.385Ω/1,000 feet and assuming that the distance A is 200 feet (and that the distance of the loop 25 is therefore 400 feet), one may determine the value of R_{wire}.

$${R}_{wire} = \frac{6.385 ohms}{1000 feet} * 400 feet = 2.554 Ω \qquad equation \#2$$

Assuming that the load 26 is a 120 W load, and assuming that power supply 24 is a 48 VDC power supply with a 960 W output, one can determine the amount of current flowing through wire portion 28a, shown as I_{wire}.

$$\begin{matrix}{V}_{load} = 48 V - {V}_{wire} & equation \#3 \\ {V}_{load} = 48 V - ( {I}_{wire} * {R}_{wire} ) & equation \#4 \\ {P}_{load} = {V}_{load} * {I}_{wire} & equation \#5 \\ {I}_{wire} = \frac{120 W}{{V}_{load}} & equation \#6\end{matrix}$$

Solving equations #3-6 yields the following values: I_{wire}=2.969 A and V_{load}=40.418V. A voltage drop percentage along the wire loop 25 and a power loss along the wire loop 25 may be determined using equations #7-8 below.

$$\begin{matrix} {V}_{drop \_ percentage} = \frac{( 48 V - 40.418 V )}{48 V} = 15.796 \% & equation \#7 \\ {P}_{wire} = {I}_{wire}^{2} * {R}_{wire} = {( 2.969 A )}^{2} * ( 2.554 Ω ) = 22.513 W & equation \#8\end{matrix}$$

Equations 7 and 8 demonstrate that along wire loop 25, 15.796% of the voltage of power supply 24 and 22.513 W of power are lost.

B. First Load Balancing Example

FIG. 3 schematically illustrates a DC voltage distribution system 30 that includes a lighting load 16 located at a distance ½*A from the DC power supply 12 and a distance ½*A from the DC power supply 14 such that two wiring loops 32a-b are formed. Assuming again that the resistance of wire is 6.385Ω/1,000 feet and assuming that the distance A is 200 feet, we get the following value for R_{wire} for each loop 32a-b:

$${R}_{wire \_ per \_ loop} = \frac{6.385 ohms}{1000 feet} * \frac{200 feet}{2} * 2 = 1.277 Ω \qquad equation \#9$$

Assuming that the load 26 is a 120 W load, and assuming that power supply 24 is a 48 VDC power supply with a 480 W output, one can calculate the value of I_{wire}. Note that in the configuration 30 we are assuming that two 480 W power supplies are used instead of a single 960 W power supply as shown in the configuration 23 of FIG. 2.

$$\begin{matrix}{V}_{load} = 48 V - {V}_{wire} & equation \#10 \\ {V}_{load} = 48 V - ( {I}_{wire} * {R}_{wire \_ per \_ loop} ) & equation \#11 \\ {P}_{load} = {V}_{load} * ( {I}_{wire} * 2 ) & equation \#12 \\ {I}_{wire} = \frac{120 W}{2 * {V}_{load}} & equation \#13\end{matrix}$$

Solving equations #10-13 yields the following values: I_{wire}=1.294 A and V_{load}=46.352V. A voltage drop percentage along the wire loops 32a-b and a power loss along the wire loops 32a-b may be determined using equations #14-15 below.

$$\begin{matrix}{V}_{drop \_ percentage} = \frac{( 48 V - 46.352 )}{48 V} = 3.433 \% & equation \#7 \\ {P}_{wire} = {I}_{wire}^{2} * {R}_{wire \_ per \_ loop} * 2 & equation \#8 \\ {R}_{wire} = {( 1.294 A )}^{2} * ( 1.277 Ω ) * 2 = 4.277 W & equation \#9\end{matrix}$$

Thus, compared to the prior art configuration 23 of FIG. 2, which has a energy loss of 22.513 W and a voltage drop of 15.976%, the configuration 30 of FIG. 3 has a energy loss of 4.277 W and a voltage drop of 3.433%, which is a significant improvement.

C. Second Load Balancing Example

FIG. 4 schematically illustrates a DC voltage distribution system 38 that includes a lighting load 16 connected to DC power supply 12 via wire 42a having a wiring length of 0.95 A, and connected to DC power supply 14 via wire 42b having a wiring length of 0.05 A, such that two wiring loops 40a-b are formed. Assuming again that the resistance of wire is 6.385Ω/1,000 feet and assuming that the distance A is 200 feet, we get the following values for each wiring loop 40a-b:

$$\begin{matrix}{R}_{wire \_ loop \_ 40 a} = \frac{6.385 ohms}{1000 ft} * ( .95 * 200 ft * 2 ) = 2.426 Ω & equation \#10 \\ {R}_{wire \_ loop \_ 40 b} = \frac{6.385 ohms}{1000 ft} * ( .05 * 200 ft * 2 ) = 0.128 Ω & equation \#11\end{matrix}$$

Assuming we have a 120 Watt load (e.g. a 120 W LED luminaire) and that the DC power supplies 12, 14 each have a voltage of 48V, one may determine the current values in the current loops 40a-b, as shown in equations #12-17 below.

P_{wire}=V_{load}*(I_{wire}_{_{—}}ₐ+I_{wire}_{_{—}}_{b})=120 W equation #12

I_{wire}_{_{—}}ₐ*R_{wire}_{_{—}}ₗₒₒₚ_{_{—}}₄₀ₐ=I_{wire}_{_{—}}_{b}*R_{wire}_{_{—}}ₗₒₒₚ_{_{—}}_{40b} equation #13

48V−V_{load}=I_{wire}_{_{—}}ₐ*R_{wire}_{_{—}}ₗₒₒₚ_{_{—}}₄₀a equation #14

This yields the following values:

I_{wire}_{_{—}}ₐ=0.126 A equation #15

I_{wire}_{_{—}}_{b}=2.390 A equation #16

V_{load}=47.695V equation #17

The voltage drop percentage along the wire loop 40a may be determined as shown in equations #18-19 below.

$$\begin{matrix}48 V - 47.695 V = 0.305 V & equation \#18 \\ {V}_{drop \_ percentage} = \frac{0.305 V}{48 V} = 0.635 \% & equation \#19\end{matrix}$$

The energy loss on the wire loops 40a-b may be determined as shown in equations #20-21.

P_{wire}=(I_{wire}_{_{—}}ₐ)²*R_{wire}_{_{—}}ₗₒₒₚ_{_{—}}₄₀ₐ+(I_{wire}_{_{—}}_{b})²*R_{wire}_{_{—}}ₗₒₒₚ_{_{—}}_{40b} equation #20

P_{wire}=(0.126 A)²*2.426Ω+(2.390 A)²*0.128Ω=0.77 W equation # 21

Thus, compared to the configuration 30, which has an energy loss of 4.277 W and a voltage drop percentage of 3.433%, the configuration 38 of FIG. 4 has an energy loss of 0.77 W and a voltage drop percentage of 0.635%. Thus, we can see that the a worst case voltage drop occurs when the load 16 has an equal wiring distance to the two DC power supplies 12, 14, as shown in the configuration 30 of FIG. 3. When the load 16 is moved closer to one of the two DC power supplies 12, 14, as shown in the configuration 38 of FIG. 4, the current flow is adjusted such that the current from the more distant of the two DC power supplies (power supply 12 in the example of FIG. 4) is reduced and a flow of current from the closer of the two DC power supplies (power supply 14 in the example of FIG. 4) is increased, further reducing overall voltage drop and power loss on wires.

In one example the DC power supplies 12, 14 set their voltages to be the same voltage prior to entering the load balancing mode. Thus, if the voltage of one of the two power supplies 12, 14 has been adjusted (e.g. in the load sharing mode) that adjustment may be reset prior to entering the load balancing mode. In one example the DC power supplies 12, 14 are never in the load balancing mode and the load sharing mode simultaneously.

Load Sharing

The system 38 of FIG. 4 may also be used to demonstrate the load sharing mode in which one of the DC power supplies 12, 14 selectively increases its voltage to prevent the other of the DC power supplies 12, 14 from exceeding its power output threshold. For the example of FIG. 4, assume that the resistance of the wires 42a is 1.588Ω/1000 ft, and assume that the load 16 is a 600 W load. This results in the following resistance values:

$$\begin{matrix}{R}_{wire \_ loop \_ 42 a} = \frac{1.588 ohms}{1000 ft} * ( .95 * 200 ft * 2 ) = 0.603 Ω & equation \#22 \\ {R}_{wire \_ loop \_ 42 b} = \frac{1.588 ohms}{1000 ft} * ( .05 * 200 ft * 2 ) = 0.0318 Ω & equation \#23\end{matrix}$$

Because each power supply is assumed to have a 480 W maximum output, a maximum amount of current from power supply 14 (shown as I_{wire}_{_{—}}_{b}) may be determined as shown in equation #24-25 below:

$${I}_{wire \_ b} = \frac{480 W}{48 V} = 10 A \qquad equation \#24$$

Thus, to avoid exceeding its maximum 480 W output, the power supply 14 may only provide 10 A of current. As shown in equations #26-31, this requires power supply 12 to enter the load sharing mode and to increase its voltage by 1.2V to source the remaining wattage required by the load 16.

V_{load}=48V−R_{wire}_{_{—}}ₗₒₒₚ_{_{—}}_{40b}*I_{wire}_{_{—}}_{b}=47.682V equation #25

V_{load}*(I_{wire}_{_{—}}ₐ+I_{wire}_{_{—}}_{b})=600 W equation #26

V_{load}=47.682V equation #27

I_{wire}_{_{—}}_{b}=10 A equation #28

I_{wire}_{_{—}}ₐ=2.583 A equation #29

Therefore,

V_{PS}_{_{—}}₁₂=V_{load}+I_{wire}_{_{—}}ₐ*R_{wire}_{_{—}}ₗₒₒₚ_{_{—}}₄₂ₐ equation #30

where V_{PS}_{_{—}}₁₂ is a voltage of DC power supply 12.

V_{PS}_{_{—}}₁₂=47.682V+1.558V=49.2V equation #31

Thus, we can see that power supply 12 has increased its output from 48V to 49.2V in the “load sharing” mode to prevent power supply 14 from exceeding its 480 W maximum output.

In one example, before either of the power supplies 12, 14 enters the load sharing mode, a check is performed to ensure that the voltage increase will not cause the power supply to exceed its own wattage threshold and the maximum allowable voltage limit of the DC voltage distribution system 38. Thus, power supply 12 may check to ensure that the increase of 1.2V to assist power supply 14 will not cause the power supply 12 to exceed its 480 W maximum wattage limit and the maximum allowable voltage limit of the DC voltage distribution system 38.

Additional Configurations

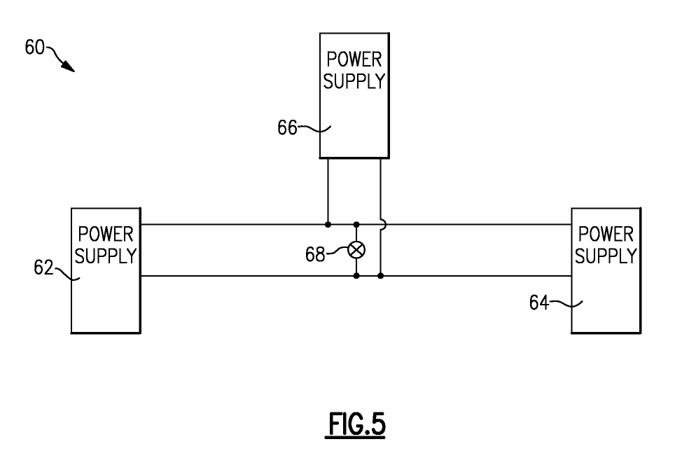

Although FIGS. 1 and 2-4 illustrate only two DC power supplies, it is understood that additional DC power supplies could be used. For example, FIG. 5 schematically illustrates a system 60 that includes three DC power supplies 62, 64, 66 that provide power to a load 68. Each of the power supplies 62, 64, 66 is connected in parallel to the load 68 and is connected in parallel to each of the other power supplies such that the load 68 is connected in parallel to each of the three power supplies 62, 64, 66. If additional power supplies were desired, more than three supplies could be used. Thus, one could achieve a desired power supply wattage using a plurality of power supplies having smaller wattages instead of using a single power supply having a larger wattage.

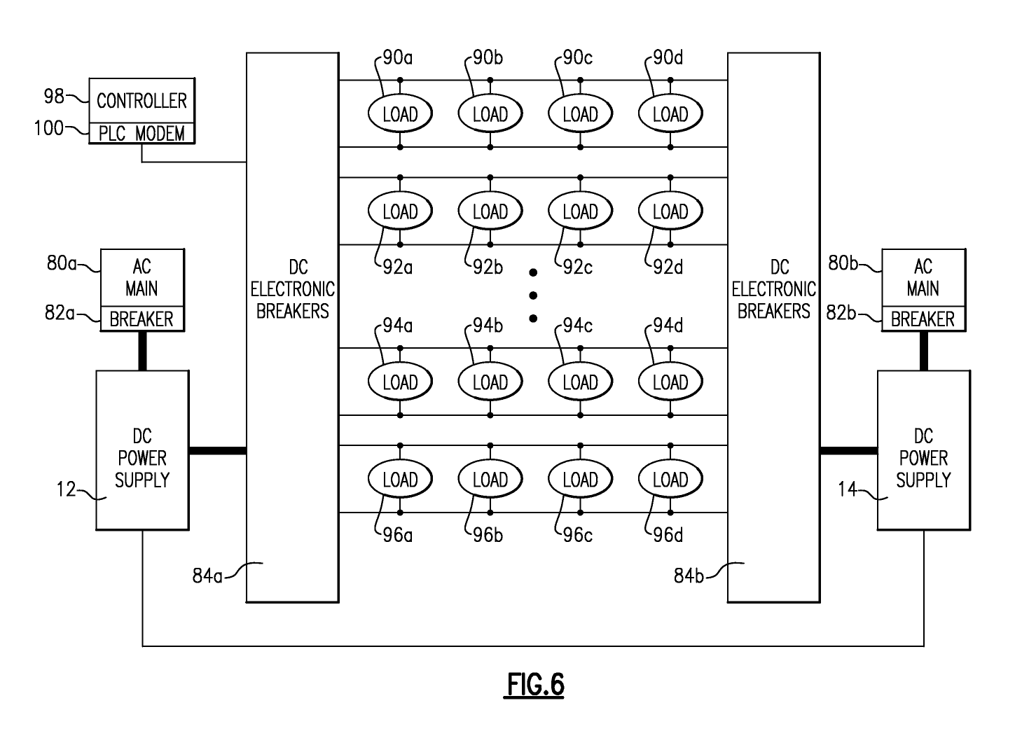

FIG. 6 schematically illustrates an implementation of the system 10 of FIG. 1 that includes two DC power supplies 12, 14 each connected to an associated AC main 80a, 80b, each AC main 80a-b having an associated breaker 82a-b. Each power supply 12, 14 has an associated electronic DC breaker 84a-b. Instead of the single set of loads 16a-d shown in FIG. 1, a plurality of sets of loads 90a-d, 92a-d, 94a-d, 96a-d are included. Of course, additional sets of loads could be included. A controller 98 communicates with the breakers 84a-b using a power line communication (“PLC”) modem 100. The controller 98 is operable to command individual loads to turn ON or OFF by sending a command over the wires connecting the loads 90-96 to the breakers 84. In one example the sets of loads 90-96 include lighting sources that the controller 98 is operable to turn ON, OFF or to dim.

Although certain example types of loads, quantities of loads, wire resistance values, wiring distances, load power ratings, power supply quantities, power supply power capacities and power supply voltages have been disclosed, it is understood that these are only examples, and that other values would be possible.

Although embodiments have been disclosed, a worker of ordinary skill in this art would recognize that certain modifications would come within the scope of this invention. For that reason, the following claims should be studied to determine the true scope and content of this invention.

What is claimed is:

1. A DC voltage distribution system, comprising:
a first DC power supply;
a second DC power supply; and
at least one load connected in parallel to the first DC power supply via a first distance of wire, and connected in parallel to the second DC power supply via a second distance of wire, the first DC power supply and second DC power supply being configured to enter a load sharing mode in which one of the first or second DC power supply selectively increases its voltage to prevent the other of the first or second DC power supply from exceeding its power output threshold, the first DC power supply and the second DC power supply also being configured to enter a load balancing mode in which the first DC power supply and the second DC power supply set their output voltage to the same value such that a flow of current on the longer of the first and second distance of wire is reduced and a flow of current on the shorter of the first and second distance of wire is increased.

2. The system of claim 1, wherein prior to entering the load sharing mode, a check is performed to ensure that the one of the first or second DC power supply that is going to increase its voltage will not exceed its own power output threshold or a maximum allowable voltage limit of the DC voltage distribution system by increasing its voltage.

3. The system of claim 1, wherein the first DC power supply and the second DC power supply set their output voltages to the same value during the load balancing mode.

4. The system of claim 1, including:
a controller operable to command the at least one load to turn ON or OFF using a powerline communication signal.

5. The system of claim 4, wherein the controller is operable to command either of the first or second DC power supply to selectively increase its voltage in the load sharing mode.

6. The system of claim 1, wherein the at least one load includes a plurality of individual loads connected in parallel to each other and to the first and second DC power supply, wherein each of the plurality of individual loads is individually controllable via powerline communication signals.

7. The system of claim 6, wherein the at least one load includes a plurality of sets of individual loads, each set of individual loads having a separate parallel connection to the first and second DC power supply.

8. The system of claim 1, wherein each of the first DC power supply and the second DC power supply are located at opposite ends of a run of wire, such that a wiring distance between the at least one load and either of the first DC power supply or the second DC power supply does not exceed a wiring distance between the first DC power supply and the second DC power supply.

9. A DC voltage distribution system, comprising:
a plurality of DC power supplies connected in parallel; and
at least one load connected in parallel to each of the DC power supplies, the DC power supplies being operable to enter a load sharing mode or a load balancing mode, wherein in the load sharing mode at least one of the DC power supplies selectively increases its voltage to prevent the other of the DC power supplies from exceeding its power output threshold, and wherein in the load balancing mode each of the DC power supplies sets their output voltage to the same value such that a flow of current from a first portion of the plurality of DC power supplies to the load is reduced and a flow of current on from a second portion of the plurality of DC power supplies is increased in response to a wiring distance from the first portion of the plurality of DC power supplies to the at least one load being longer than a wiring distance from the second portion of the plurality of DC power supplies to the at least one load.

10. The system of claim 9, wherein the plurality of DC power supplies includes three or more DC power supplies.

11. A method of distributing DC voltage, comprising:
distributing DC current to at least one load from each of a first DC power supply and a second DC power supply, the at least one load being connected in parallel to each of the first and second DC power supply;
selectively increasing a voltage of one of the first or second DC power supplies to prevent the other of the first or second DC power supplies from exceeding its power output threshold in a load sharing mode; and
setting the output voltage of the first DC power supply and the output voltage of the second DC power supplies to the same value in a load balancing mode such that a flow of current from one of the first or second DC power supplies that has a shorter wiring distance to the at least one load is increased and a flow of current from the other of the first or second DC power supplies that has a longer wiring distance to the at least one load is decreased.

12. The method of claim 11, the first and second DC power supplies being part of a DC voltage distribution system, the method including:
performing a check to ensure that the one of the first or second DC power supply that is going to increase its voltage will not exceed its own power output threshold or a maximum allowable voltage limit of the DC voltage distribution system by increasing its voltage.

13. The method of claim 11, including:
connecting the first DC power supply to the second DC power supply in parallel; and
connecting the at least one load in parallel to each of the first and second DC power supply such that a wiring distance between the at least one load and either of the first or second DC power supply does not exceed a wiring distance between the first DC power supply and the second DC power supply.

14. The method of claim 11, including:
setting a voltage of the first DC power supply and a voltage of the second DC power supply to the same value to facilitate entry into the load balancing mode.

15. The method of claim 11, including:
connecting at least one third DC power supply in parallel to each of the first DC power supply, the second DC power supply, and the at least one load, the at least one third DC power supply also being operable to enter the load sharing mode and the load balancing mode.

16. The method of claim 11, including:
commanding the at least one load to turn ON or OFF using a powerline communication signal.

17. The method of claim 11, wherein the at least one load includes a plurality of individual loads all separately controllable via powerline communication signals.
